(19) United States
(12) Patent Application Publication
(10) Pub. No.: US 2020/0380572 A1
(43) Pub. Date: Dec. 3, 2020

(54) System and Method for Dynamically Pricing Event Tickets

(71) Applicant: Event Dynamic, Dallas, TX (US)

(72) Inventor: Robert D. Smith, Dallas, TX (US)

(73) Assignee: Event Dynamic, Dallas, TX (US)

(21) Appl. No.: 16/427,630

(22) Filed: May 31, 2019

(51) Int. Cl. G06Q 30/02; G06Q 10/02; G06N 20/00

(52) U.S. Cl. CPC G06Q 30/0283; G06N 20/00; G06Q 10/02

(57) ABSTRACT

A method and system of dynamically pricing tickets for an event is disclosed herein. A computing system retrieves historical pricing information for a given team. The historical pricing information includes ticket sale information for a plurality of events. The computing system generates a predictive model using a machine learning model. The computing system receives a set of tickets for an upcoming event. The upcoming event is between the given team and an opponent. The computing system generates, via the predictive model, an event score and a spring value for the upcoming event based on historical ticket sale data for the given team, team-specific information, and opponent-specific information. The computing system constructs a price for each ticket in the set of tickets based on parameters of each ticket, the event score, and the spring value.

### CROSS-REFERENCE TO RELATED APPLICATIONS

This application is related to U.S. application Ser. No. 16/284,670, filed Feb. 25, 2019, which is hereby incorporated by reference in its entirety.

### FIELD OF THE DISCLOSURE

The present disclosure generally relates to a system and method for dynamically pricing tickets for an event.

### BACKGROUND

Currently, the majority of tickets for assorted events (e.g., sporting events, concerts, plays, etc.) are purchased online. Not only can users purchase tickets for events on primary ticket purchasing platforms, but users are now able to purchase tickets for events through a plurality of secondary ticket purchasing platforms. Such platforms typically based the pricing of tickets solely on demand for such tickets.

### SUMMARY

Embodiments disclosed herein generally relate to a system and method for dynamically pricing event tickets. In some embodiments, a method of dynamically pricing tickets for an event is disclosed herein. A computing system retrieves historical pricing information for a given team. The historical pricing information includes ticket sale information for a plurality of events. The computing system generates a predictive model using a machine learning model by generating a plurality of input data sets based on historical pricing information, wherein each input data set comprises team-specific information, opponent-specific information, and historical ticket sale data and learning, by the machine learning model, an event score and spring value price for each event of the plurality of events based at least on the team-specific information, opponent-specific information, and historical ticket sale data. The computing system receives a set of tickets for an upcoming event. The upcoming event is between the given team and an opponent. The computing system generates, via the predictive model, an event score and a spring value for the upcoming event based on historical ticket sale data for the given team, team-specific information, and opponent-specific information. The computing system constructs a price for each ticket in the set of tickets based on parameters of each ticket, the event score, and the spring value.

In some embodiments, a system is disclosed herein. The system includes a processor and a memory. The memory has programming instructions stored thereon, which, when executed by the processor, perform one or more operations. The one or more operations include retrieving historical pricing information for a given team. The historical pricing information includes ticket sale information for a plurality of events. The one or more operations further include generating a predictive model using a machine learning model by generating a plurality of input data sets based on historical pricing information, wherein each input data set comprises team-specific information, opponent-specific information, and historical ticket sale data and learning, by the machine learning model, an event score and spring value price for each event of the plurality of events based at least on the team-specific information, opponent-specific information, and historical ticket sale data. The one or more operations further include receiving a set of tickets for an upcoming event. The upcoming event is between the given team and an opponent. The one or more operations further include generating, via the predictive model, an event score and a spring value for the upcoming event based on historical ticket sale data for the given team, team-specific information, and opponent-specific information. The one or more operations further include constructing a price for each ticket in the set of tickets based on parameters of each ticket, the event score, and the spring value.

In some embodiments, a non-transitory computer readable medium is disclosed herein. The non-transitory computer readable medium includes one or more sequences of instructions that, when executed by the one or more processors, causes one or more operations. The one or more operations include retrieving historical pricing information for a given team. The historical pricing information includes ticket sale information for a plurality of events. The one or more operations further include generating a predictive model using a machine learning model by generating a plurality of input data sets based on historical pricing information, wherein each input data set comprises team-specific information, opponent-specific information, and historical ticket sale data and learning, by the machine learning model, an event score and spring value price for each event of the plurality of events based at least on the team-specific information, opponent-specific information, and historical ticket sale data, such that attendance for each event is targeted. The one or more operations further include receiving a set of tickets for an upcoming event. The upcoming event is between the given team and an opponent. The one or more operations further include generating, via the predictive model, an event score and a spring value for the upcoming event based on historical ticket sale data for the given team, team-specific information, and opponent-specific information, such that attendance for the upcoming event is targeted. The one or more operations further include constructing a price for each ticket in the set of tickets based on parameters of each ticket, the event score, and the spring value.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of training a prediction model, according to example embodiments.

FIG. 3 is a block diagram illustrating a method of generating a generic prediction model, according to example embodiments.

FIG. 4 is a flow diagram illustrating a method of generating a team-specific prediction model, according to example embodiments.

FIG. 5 is a flow diagram illustrating a method of dynamically pricing tickets for an event, according to example embodiments.

FIG. 6 is a block diagram illustrating one or more operations associated with dynamically pricing tickets for an event, according to example embodiments.

FIG. 7 is a block diagram illustrating a computing environment, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and method for dynamically pricing event tickets. Conventional approaches to pricing tickets for an event (e.g., a sports game, event, musical, concert, play, etc.) typically rely solely on demand for adjusting price in the lead up to an event. One of the issue with relying solely on demand is the inability to more effectively price tickets when such tickets are initially posted to a ticket sale platform. For example, conventional approaches typically use coded algorithms to price tickets based on (1) current secondary market listing data and (2) anticipated demand, far in advance of an event. Further, secondary listings in conventional systems may be manipulated by ticket brokers.

The one or more techniques disclosed herein improve upon conventional processes through the use of machine learning to more accurately price tickets both at the outset and during the sale of tickets by generating an event score and spring value for each event. For example, one or more machine learning algorithms disclosed herein leverage not only ticket demand, but also weather conditions surrounding the game, quality of opponent, quality of the home team, type of game, whether the game is a rivalry game, the city in which the game takes place, and the like. Such information may be dynamically updated up to initiation of the event, such that the price of each ticket is accurately set. As such, through this self-learning system, tickets may be priced based on, for example, event-specific conditions, such as sales velocity and historic sales record.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

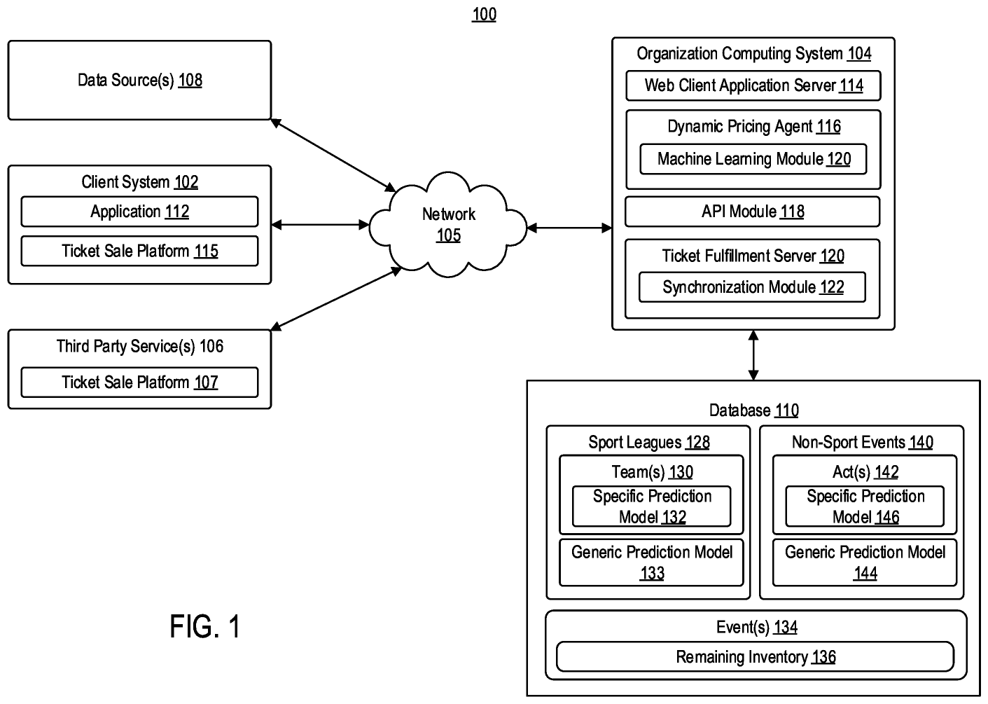

FIG. 1 is a block diagram illustrating a computing environment 100, according to one embodiment. Computing environment 100 may include at least a client system 102, third party services 106, data sources 108, an organization computing system 104, and a database 110 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of system 100.

Client system 102 may include one or more computing devices operable by end users. For example, such computing devices may be a mobile device, a tablet, a desktop computer, or any computing system having the capabilities described herein. Client system 102 may represent subscribers, clients, prospective clients, or customers of an entity associated with organization computing system 104, such as individuals who have obtained, will obtain, or may obtain a product, service, or consultation from an entity associated with organization computing system 104.

Client system 102 may include at least application 112 and ticket sale platform 115. Application 112 may be representative of a web browser that allows access to a website or a stand-alone application. Client system 102 may access application 112 to access functionality of organization computing system 104. In some embodiments, client system 102 may communicate over network 105 to request a webpage, for example, from web client application server 114 of organization computing system 104. For example, client system 102 may be configured to execute application 112 to access content managed by web client application server 114. In some embodiments, client system 102 may access application 112 to access functionality of one or more third party services 106. The content that is displayed to client system 102 may be transmitted from web client application server 114 or third party service 106 to client system 102, and subsequently processed by application 112 for display through a graphical user interface (GUI) of client system 102.

Ticket sale platform 115 may include one or more servers configured to host a website for ticket sales. For example, users may navigate to a ticket sale website hosted by ticket sale platform 115 to purchase tickets to an event. In some examples, ticket sale platform 115 may be configured to host tickets for at least one of sporting events, concert events, performing arts events, and the like.

In operation, client system 102 may communicate with organization computing system 104 to request ticket pricing services provided by organization computing system 104. For example, client system 102 may work in conjunction with organization computing system 104 for the dynamic pricing of tickets for available events.

Third party services 106 may represent one or more ticket exchange services. Each third party service 106 may be referred to as a “secondary integration.” In other words, in addition to hosting tickets for an event on a primary integration (e.g., ticket sale platform 115 or a ticket sale platform associated with organization computing system 104), a client may choose to also host tickets for the event on a secondary integration (e.g., StubHub™, SeatGeek®, and the like).

Accordingly, each third party service 106 may include its own dedicated ticket sale platform 107. Ticket sale platform 107 may include one or more servers configured to host a website for ticket sales. For example, users may navigate to a ticket sale website hosted by ticket sale platform 107 to purchase tickets to an event. In some examples, ticket sale platform 107 may be configured to host tickets for at least one of sporting events, concert events, performing arts events, and the like.

Organization computing system 104 may include at least web client application server 114, dynamic pricing agent 116, application programming interface (API) module 118, and ticket fulfillment server 120. Each of dynamic pricing agent 116, API module 118, and ticket fulfillment server 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of an instructions.

Dynamic pricing agent 116 may be configured to dynamically price each ticket for a given event. For example, dynamic pricing agent 116 may be configured to dynamically price each ticket for a given event, based on, for example, one or more of win/loss ratio of each team in the event, forecasted weather conditions, number of tickets available, location of each seat, velocity of ticket sales, quality of opponent, event location, and the like. Dynamic pricing agent 116 may price each ticket by generating a score and a spring value for each game. Dynamic pricing agent 116 may include machine learning module 124.

Machine learning module 124 may be configured to dynamically price each available ticket for an event. For example, machine learning module 124 may be configured to learn how to generate a score for each game and a spring value for each game. In some embodiments, the score for each game may correspond to the lowest priced ticket for the event. In some embodiments, a spring value may represent a multiplier or scalar that reflects the percentage change between sections or rows in an event venue. For example, the relationship between the spring value and the event score may be such that when the event score changes the spring value may automatically change as well. Accordingly, by applying the spring value to the lowest priced ticket for the event, dynamic pricing agent 116 may extrapolate or generate a price for each seat in the venue. In some embodiments, such parameters may include, but are not limited to, win/loss ratio of each team in the event, forecasted weather conditions, number of tickets available, location of each seat, velocity of ticket sales, quality of opponent, event location, day of the week, time of the event, and the like. In some embodiments, such parameters may further include, but are not limited to, sales history of an artist (e.g., musician, playwright, etc.) at a given venue, venue type, forecasted weather conditions, number of tickets available, type of event (e.g., music tour, final music tour, music tour following an album release, play, musical, circus, monster car rally, wrestling event, movie, etc.), quality of the act, event location, and the like.

In some embodiments, machine learning module 124 may generate a prediction model for each of the event score and spring value. For example, machine learning module 124 may generate a first prediction model to generate an event score and a second prediction model to generate the spring value.

Machine learning module 124 may be able to continually update the event score for each event and the spring value periodically. For example, machine learning module 124 may be configured to dynamically update the price of each ticket every 15 minutes. Machine learning module 124 may use one or more of a decision tree learning model, association rule learning model, artificial neural network model, deep learning model, inductive logic programming model, support vector machine model, clustering mode, Bayesian network model, reinforcement learning model, representational learning model, similarity and metric learning model, rule based machine learning model, and the like to train the prediction model.

In some embodiments, dynamic pricing agent 116 may be configured to price tickets with the specific goal of targeting or maximizing attendance. For example, a user or client may request that dynamic pricing agent 116 switch from a revenue based approach (e.g., increasing the amount of revenue generated through ticket sales) to an attendance based approach, through which the attendance for a given event is increased (e.g., improved). Accordingly, in some embodiments, machine learning module 124 may train a prediction model, such that tickets may be priced in a manner that increases or maximizes event attendance. For example, machine learning module 124 may train a prediction model to generate an event score and spring value that is intended to maximize intendance for the event. Machine learning module 124 may train the prediction model as recited above; however, certain weights of the machine learning algorithm may change to ensure that the prediction model generates an event score and a spring value that prices tickets in a way that increases ticket sales.

In some embodiments, a user or customer may provide a desired attendance number or percentage to dynamic pricing agent 116. For example, a user may provide input to dynamic pricing agent 116 to request that dynamic pricing agent 116 implements a prediction model that maximizes attendance (e.g., a sold out event). In another example, a user may provide input to dynamic pricing agent 116 to request that dynamic pricing agent 116 implement a prediction model that increases attendance, but not to sold out levels (e.g., about 80% of the tickets are sold).

In some embodiments, dynamic pricing agent 116 may determine that a user's requested or desired attendance number or percentage is not feasible. For example, given the home team, the away team, and the day for a given event, dynamic pricing agent 116 may determine that it is nearly impossible to sell out the venue. In some embodiments, dynamic pricing agent 116 may make this determination using the trained prediction model. For example, the prediction model may output a N/A value for the event score, reflecting the difficulty in achieving the user's desired attendance number or percentage.

Still further, in some embodiments, dynamic pricing agent 116 may provide the user with expected revenue, upon receiving a desired attendance number or percentage. For example, dynamic pricing agent 116 may generate the expected revenue, based on the event score and spring value generated for the event given the desired attendance number or percentage.

API module 118 may include one or more instructions to execute one or more APIs that provide various functionalities related to the operations of organization computing system 104. In some embodiments, API module 118 may include an API adapter that allows API module 118 to interface with and utilize enterprise APIs maintained by organization computing system 104 and/or an associated entity that may be homed on other systems or devices. In some embodiments, APIs may enable organization computing system 104 to communicate with one or more of client system 102, data sources 108, and third party services 106. For example, organization computing system 104 may be configured to retrieve one or more sets of data from one or more endpoints defined at one or more data sources 108. Similarly, organization computing system 104 may be configured to receive or retrieve one or more sets of ticket sales data from an endpoint defined at a third party service 106.

Ticket fulfillment server 120 may be configured to fulfill one or more ticket orders. For example, ticket fulfillment server 120 may be configured to maintain an inventory of tickets, as users purchase tickets. In some embodiments, ticket fulfillment server 120 may receive ticket orders directly, via a ticket sale platform hosted by organization computing system 104. In some embodiments, ticket fulfillment server 120 may receive ticket orders via one or more primary integrations (e.g., ticket sale platform 112) or one or more secondary integrations. For example, ticket fulfillment server 120 may receive ticket orders via one or more third party services 106, which may be configured to host a dedicated ticket sale platform. In some embodiments, ticket fulfillment server 120 may poll one or more of primary integrations (e.g., ticket sale platform 112) and secondary integrations (e.g., ticket sale platform 107) to retrieve ticket orders.

Ticket fulfillment server 120 may include synchronization module 122. Synchronization module 122 may be configured to synchronize database 110 with tickets currently available via organization computing system 104, client system 102, or third party service 106. For example, upon receiving one or more ticket transactions via a third party service 106, synchronization module 122 may synchronize the data with database 110 and one or more of organization computing system 104 and client system 102. Synchronizing the ticket sale information with database 110 and one or more of organization computing system 104 and client system 102 may aid in ensuring that no ticket is sold twice. Further, synchronizing the ticket sale information with database 110 may aid in dynamically pricing unsold tickets. For example, machine learning module 124 may leverage ticket sale information to determine an updated event score and/or updated spring score based on, for example, the velocity at which other tickets for the event are being sold.

Database 110 may include sports leagues 128, events 134, and non-sporting events 140. Sport leagues 128 may be representative of any sports league for which organization computing system 104 or a third party services 106 sells tickets. For example, sports leagues 128 may be representative of National Football League (NFL®), National Basketball Association (NBA®), National Hockey Association (NHL®), Major League Baseball (MLB®), Major League Soccer (MLS®), and the like. Each sport league 128 may include a plurality of teams 130 and a generic prediction model 133. Each team 130 may be representative of a team associated with a respective sports league 128. Each team 130 may include a specific prediction model 132 corresponding thereto. Each specific prediction model 132 may be generated by machine learning module 124, such that each respective specific prediction model 132 may be tailored to a given team. For example, each specific prediction model 132 may be tuned in a way that accounts for rivals of a given team 130, city in which the respective team plays, type of stadium the team plays in, and the like. Accordingly, each specific prediction model 132 may be configured to generate an event score and spring value for that specific team.

Generic prediction model 133 may correspond to an event score/spring value prediction model generated by machine learning module 124 for each sports league 128. Machine learning module 124 may generate generic prediction model 133 by analyzing a set of specific prediction models 132 and extracting common traits among the specific prediction models 132. In other words, machine learning module 124 may generative generic prediction model 133 by generalizing a set of specific prediction models 132 generated by machine learning module 124. Accordingly, rather than generating a specific prediction model 132 for each team from scratch, machine learning module 124 may utilize generic prediction model 133 as a baseline model upon which to build. As such, generic prediction model 133 may be configured to generate an event score and spring value for any team.

Events 134 may correspond to each active sporting event. For example, events 134 may include remaining inventory 136. Remaining inventory 136 may correspond to one or more unsold tickets for each event 134. Non-sporting events 140 may be directed to events such as, but not limited to, concerts, musicals, plays, circus, rodeo, etc. Each non-sporting event 140 may include one or more acts 142. Each act 142 may be representative of a performance associated with a category of non-sporting events 140. For example, given a concert, each act 142 may be directed to a musician.

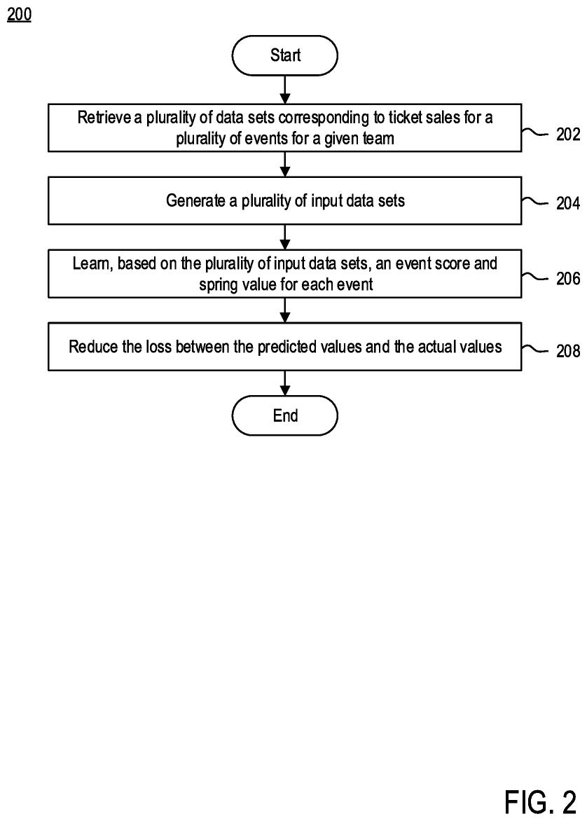

FIG. 2 is a flow diagram illustrating a method 200 of generating a prediction model, according to example embodiments. Method 200 may begin at step 202.

At step 202, organization computing system 104 may retrieve a plurality of data sets corresponding to ticket sales for a given event. For example, dynamic pricing agent 116 may retrieve from database 110 historical ticket sales for a plurality of events.

In some examples, the event may be a sporting event. For example, each event may correspond to an event for which the team is the home team. In other words, dynamic pricing agent 116 may not take into consideration historical pricing data for events in which the target team is the away team. Each event may include one or more parameters associated therewith. For example, each event may include at least one or more of a win/loss ratio of the home team (i.e., the target team) on the date of the event, a win/loss ratio of the away team on the date of the event, a time of the event, a location of the event, a type of facility associated with the event, an indication as to whether the event is a rivalry game, weather conditions of the game, and the like. In some examples, each event may include data related to ticket sales for the event. For example, each event may include data directed to the velocity of ticket sales (i.e., the speed at which tickets are bought), which seats/row were sold, remaining inventory, and the like.

In some examples, the event may be a non-sporting event (e.g., concert, circus, play, musical, etc.). Each event may include one or more parameters associated therewith. For example, each event may include at least one or more of a type of event (e.g., concert, circus, musical, etc.), an act associated with the event (e.g., musical artist, playwright, circus-act, etc.), ticket sale data, and the like.

At step 204, organization computing system 104 may generate a plurality of input data sets for machine learning module 124. For sporting events, dynamic pricing agent 116 may generate a plurality of training sets and a plurality of testing sets to train a prediction model corresponding to the respective team. In some embodiments, the input data sets may include a set of data corresponding to each event from the data sets retrieved in step 202. For example, each input data set may correspond to a given event, and may include information directed to a win/loss ratio of the home team (i.e., the target team) on the date of the event, a win/loss ratio of the away team on the date of the event, a time of the event, a location of the event, a type of facility associated with the event, an indication as to whether the event is a rivalry game, weather conditions of the game, velocity of ticket sales, which seats/rows were sold and at which price, remaining inventory, and the like.

For non-sporting events, dynamic pricing agent 116 may generate a plurality of training sets and a plurality of testing sets to train a prediction model corresponding to a respective act. In some embodiments, the input data sets may include a set of data corresponding to each event from the data sets retrieved for non-sporting events in step 202. For example, each input data set may correspond to a given event, and may include information directed to a type of event (e.g., concert, circus, musical, etc.), an act associated with the event (e.g., musical artist, playwright, circus-act, etc.), ticket sale data, and the like.

At step 206, organization computing system 104 may learn, based on the plurality of input data sets, an event score and a spring value for a given event. For example, dynamic pricing agent 116 may learn, via machine learning module 124, how to generate an event score and spring value for an event based on one or more attributes for the event and the ticket. Accordingly, for each ticket, machine learning module 124 may generate a prediction model that may be able to generate an event score and spring value based on, for example, seat, row, section, win/loss ratio of the home team, quality of opponent, city in which the event is taking place, whether it is a rivalry game, weather forecast, time of day, ticket inventory remaining, velocity at which tickets sell, a type of event (e.g., concert, circus, musical, etc.), an act associated with the event (e.g., musical artist, playwright, circus-act, etc.), ticket sale data, and the like. By developing such prediction model, dynamic pricing agent 116 may be configured to continually update the event score and spring value up to the point of sale, or, at the very latest, up to the start of the event.

In other words, because some of the inputs to prediction model are dynamic (i.e., changing), the event score and/or spring value generated by prediction model on day one may not reflect the event score and/or spring value generated by prediction model on day two. Such dynamic variables may include, for example, weather forecast, win/loss ratio of the home team, quality of opponent, ticket inventory remaining, velocity at which tickets sell, an act associated with the event (e.g., an opening band added or removed from the event), album sales corresponding to an act, popularity of the act associated with the event, and the like.

In some embodiments, machine learning module 124 may embed one or more rules in the prediction model. In some examples, machine learning module 124 may place an event score floor to prevent dynamic scoring below a threshold level.

At step 208, organization computing system 104 may reduce the loss between predicted values and actual values. For example, dynamic pricing agent 116 may reduce the loss between the generated event score and the actual event score (e.g., lowest priced ticket). In another example, dynamic pricing agent 116 may reduce the loss between the generated spring value and the actual spring value. Exemplary loss functions may include, but are not limited to, cross-entropy loss, hinge, Huber, Kullback-Leibler, mean absolute error, mean squared error, and the like. By identifying the error between the predicted values and the actual values, dynamic pricing agent 116 may tweak the prediction model and continue the training process. Further, in some embodiments, an administrator may manually modify the prediction model based on industry knowledge. For example, if an administrator identifies that two teams are rivals, but the prediction algorithm did not identify the teams as such, the administrator may manually modify the prediction algorithm to identify the teams as rivals in future iterations. In some embodiments, one or more parameters may also be used to fine tune or improve performance speed of the prediction model.

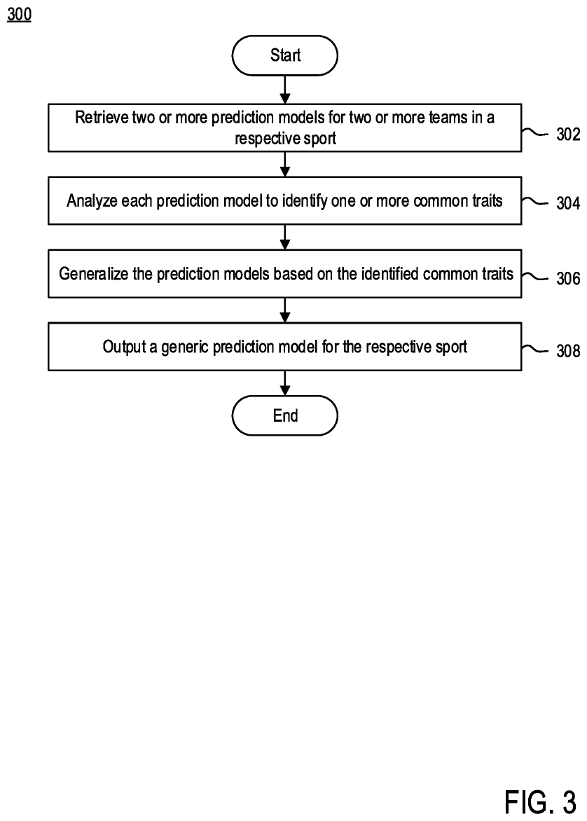

FIG. 3 is a flow diagram illustrating a method 300 of generating a generic prediction model, according to example embodiments. Method 300 may begin at step 302.

At step 302, organization computing system 104 may retrieve two or more prediction models for two or more teams. For example, dynamic pricing agent 116 may retrieve two or more specific prediction models 132 that were generated for two or more respective teams from database 110. Each specific prediction model 132 may have been generated by machine learning module 124 for a given team.

At step 304, organization computing system 104 may analyze each prediction model to identify one or more common traits across each prediction model. For example, dynamic pricing agent 116 may parse each specific prediction models 132 to identify common characteristics of each model. In some embodiments, such common characteristics may include, but are not limited to, weights associated with each of a win/loss ratio of the home team (i.e., the target team) on the date of the event, a win/loss ratio of the away team on the date of the event, a time of the event, a location of the event, a type of facility associated with the event, an indication as to whether the event is a rivalry game, weather conditions of the game, the velocity of ticket sales (i.e., the speed at which tickets are bought), which seats/row were sold, remaining inventory, and the like.

At step 306, organization computing system 104 may generalize the specific prediction models based on the identified common traits. For example, dynamic pricing agent 116 may generalize the common traits identified in step 304 to generate a generic prediction model that is applicable to each team in a given sports league or city. At step 308, organization computing system 104 may output the generic prediction model.

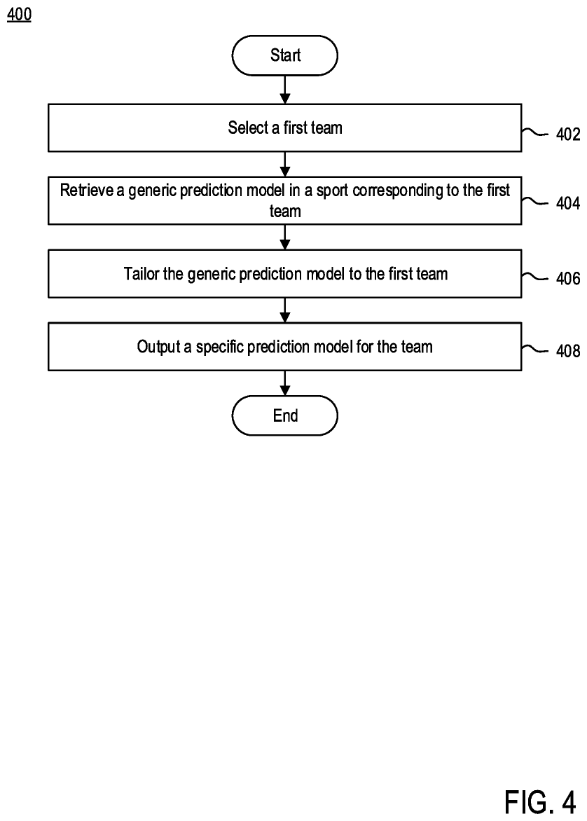

FIG. 4 is a flow diagram illustrating a method 400 of generating a specific prediction model, according to example embodiments. Method 400 may begin at step 402.

At step 402, organization computing system 104 may select a first team in a sports league. For example, dynamic pricing agent 116 may select a first team for which a specific prediction model has yet to be generated.

At step 404, organization computing system 104 may retrieve a generic prediction model for a sport associated with the first team. For example, upon selecting the first team, dynamic pricing agent 116 may retrieve, from database 110, a generic prediction model 132 associated with a sports league to which the first team is a member.

At step 406, organization computing system 104 may tailor the generic prediction model to the first team. For example, dynamic pricing agent 116 may modify one or more weights of the generic prediction model to more accurately predict an event score and a spring value for the first team. In some embodiments, modifying one or more weights of the generic prediction model may include modifying at least one of a win/loss ratio of the home team (i.e., the target team) on the date of the event, a win/loss ratio of the away team on the date of the event, a time of the event, a location of the event, a type of facility associated with the event, an indication as to whether the event is a rivalry game, weather conditions, and the like.

For example, dynamic pricing agent 116 may analyze data associated with the first team and determine that Team B and Team C are rivals of the first team, instead of a generic single team. In some embodiments, dynamic pricing agent 116 may analyze data associated with the first team and determine that Team B has an event occurring on the same day within the same city.

In another example, dynamic pricing agent 116 may determine that the facility associated with the event is an older facility, which may correspond to less turnout at events.

In yet another example, dynamic pricing agent 116 may determine that weather does not affect a turnout of a game for the first team because the first team is one of the few teams in football to play in an enclosed stadium. Accordingly, dynamic pricing agent 116 may adjust the weights associated with each variable.

At step 408, organization computing system 104 may output a specific prediction model for the first team. For example, dynamic pricing agent 116 may output a specific prediction model for the first team, and store the specific prediction model in database 110.

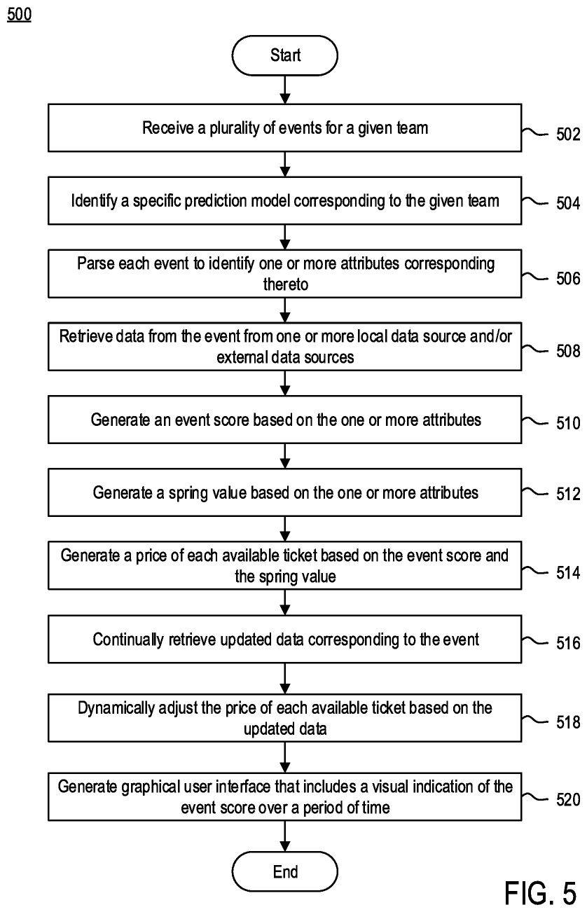

FIG. 5 is a flow diagram illustrating a method 500 of dynamically pricing tickets for an event, according to example embodiments. Method 500 may begin at step 502.

At step 502, organization computing system 104 may receive a plurality of events for an act. In some embodiments, the act may be a sports team. In some embodiments, the act may be a musical artist. In some embodiments, the act may be a play, musical, movie, etc. For purposes of the below discussion, the act may be a sports team. Those skilled in the art may understand that such processes may be applied to any such act, depending on the input data provided and the prediction model selected.

Dynamic pricing agent 116 may receive at least one event and information corresponding thereto for which to generate ticket prices. Each event may include a plurality of tickets corresponding thereto. In some embodiments, each ticket may include at least one or more of a section, row, and seat. In some embodiments, each ticket may include at least a section (e.g., general admission section, standing room only, etc.).

At step 504, organization computing system 104 may identify a specific prediction model corresponding to each event. For example, dynamic pricing agent 116 may identify a home team corresponding to each event. Based on the home team, dynamic pricing agent 116 may retrieve from database 110 a specific prediction model 132 corresponding to the home team of each event.

At step 506, organization computing system 104 may parse each event to identify one or more attributes corresponding thereto. For example, dynamic pricing agent 116 may parse each event to identify, at least one or more of, a home team, an away team, a date of the event, a time of the event, a number of available tickets for the event, an event type (e.g., regular season, playoffs, championship, pre-season, etc.), a city in which the event takes place, and the like.

At step 508, organization computing system 104 may retrieve data from the event from one or more local data source and/or external data sources. For example, dynamic pricing agent 116 may retrieve from at least one local data source and/or external data source information related to win/loss ratio of the home team, win/loss ratio of the away team, weather forecast for the day and time of the event, and the like. Generally, dynamic pricing agent 116 may be configured to retrieve team specific data and event conditions from local data sources and/or external data sources.

At step 510, organization computing system 104 may generate an event score based on the identified attributes of the event. For example, dynamic pricing agent 116 may generate a lowest priced ticket corresponding to the respective event using a specific prediction model 132. Dynamic pricing agent 116 may generate the event score for each event by providing to specific prediction model 132 at least one of a date of the event, a time of the event, a number of available tickets for the event, an event type (e.g., regular season, playoffs, championship, pre-season, etc.), a city in which the event takes place, win/loss ratio of the home team, win/loss ratio of the away team, weather forecast for the day and time of the event, and the like. Accordingly, dynamic pricing agent 116 may generate the event score based on event specific data, historical ticket sale information, event conditions, and the like.

At step 512, organization computing system 104 may generate a spring value based on the identified attributes of the event and historical ticket sale information. For example, dynamic pricing agent 116 may generate a spring value corresponding to the respective event using specific prediction model 132. Dynamic pricing agent 116 may generate the spring value for each event by providing specific prediction model 132 with at least one of a date of the event, a time of the event, a number of available tickets for the event, an event type (e.g., regular season, playoffs, championship, pre-season, etc.), a city in which the event takes place, win/loss ratio of the home team, win/loss ratio of the away team, weather forecast for the day and time of the event, historical ticket sale information, and the like. Accordingly, dynamic pricing agent 116 may generate the spring value based on event specific data, historical ticket sale information, event conditions, and the like.

At step 514, organization computing system 104 may generate a price of each available ticket for each event based on the generated event score and the generated spring value. For example, using the generated spring value, dynamic pricing agent 116 may generate a price for each specific ticket based on the event score and ticket attribute information. Ticket attribute information may include, but is not limited to, the seat, section, and/or row of each ticket to be priced.

For example, using the generated event score and spring value, dynamic pricing agent 116 may price any given ticket within the venue. First, dynamic pricing agent 116 may predict an event score and spring value based on dynamically changing factors, such as those described above. In a specific example, assume the event score is 6.0 and the spring value is 2%. These values may be fed back into the prediction model that then calculates the ticket prices based on the venue configuration. The event score represents a ticket in the venue and all other seat prices depend on this initial ticket's value. The spring value controls the spread between the event score seat and all other seats in the venue. In this example, the Event Score is $6, so every other seat in the venue will be priced in relation to this ticket's $6 price. The percentage at which any given seat is above or below the event score depends on the location of the seat in comparison to the event score seat, and the spring value. A spring value of 2% indicates a larger spread between the event score seat and a seat in row 1 in a more favorable section than a spring value of 1.5%. Dynamic pricing agent 116 may then generate a price for each ticket (e.g., Section 114, Row 1, Seat 1 or Section 114, Row 1, Seats 1-4, or all the seats. Prediction model may then return the pricing for that specific seat or group of seats based upon the event score and spring value.

At step 516, organization computing system 104 may continually retrieve or receive updated data corresponding to the event. For example, after each ticket for an event is priced and those tickets are posted to a ticket buying platform, dynamic pricing agent 116 may continually or periodically update the price corresponding to each ticket, based on new or updated information. In some embodiments, the new or updated information may correspond to a number of tickets purchased for the event, a velocity at which the tickets have been purchased, updated win/loss ratio for the home team, time before the event, updated win/loss ratio for the away, updated weather condition information for the event, and the like.

At step 518, organization computing system 104 may dynamically adjust the price of each available ticket based on the updated information. For example, dynamic pricing agent 116 may continually update an event score and spring value based on a date of the event, a time of the event, a number of available tickets for the event, velocity of ticket sales, an event type (e.g., regular season, playoffs, championship, pre-season, etc.), a city in which the event takes place, updated win/loss ratio of the home team, updated win/loss ratio of the away team, updated weather forecast for the day and time of the event, and the like. Accordingly, as the updated event scores and updated spring values are generated, dynamic pricing agent 116 may generate updated prices for each respective ticket based on the updated event scores, the updated spring values, and at least one of a seat number, a seat row, and a seat section.

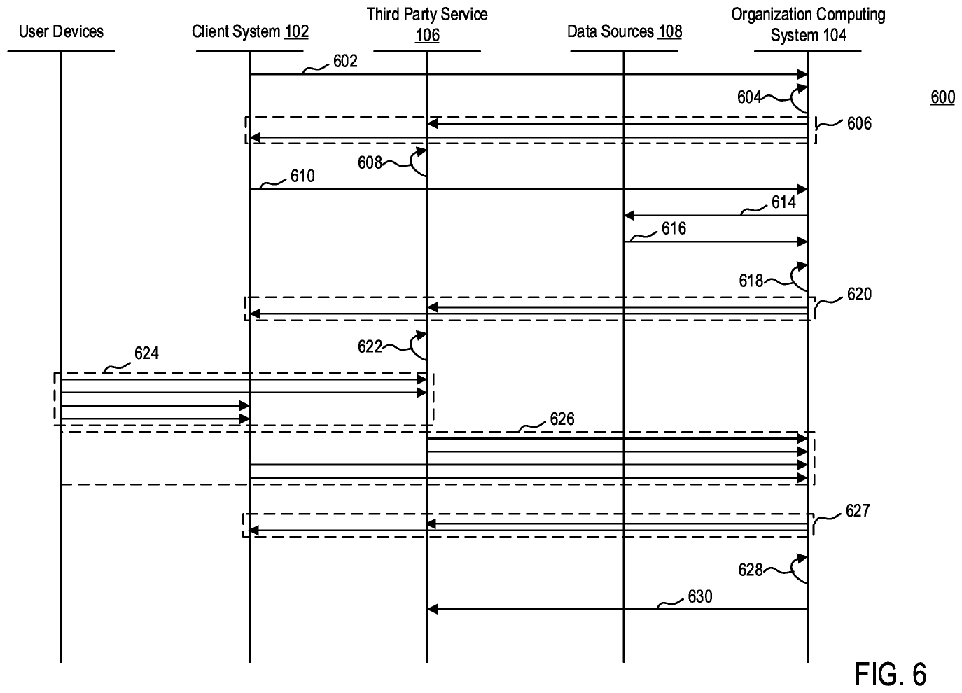

FIG. 6 is a block diagram 600 illustrating one or more operations associated with dynamically pricing tickets for an event, according to example embodiments. As briefly discussed in conjunction with FIG. 1, in some embodiments, organization computing system 104 may host its own ticket buying platform, through which end users may purchase tickets to one or more events. In some embodiments, organization computing system 104 may work in conjunction with a primary integration (e.g., ticket sale platform 115). In some embodiments, organization computing system 104 may also work in conjunction with a secondary integration (e.g., ticket sale platform 107 of one or more third party services 106). Organization computing system 104 may work in conjunction with client system 102 and a third party service 106 via one or more APIs generated by API module 118.

At operation 602, a client system 102 may request that organization computing system 104 interface with a third party service 106. For example, client system 102 may access a client portal hosted on organization computing system 104. Via the client portal, client system 102 may request that tickets associated with the client be posted to a third party service 106 by toggling a secondary integration option. In some embodiments, client system 102 may request that the tickets be sold exclusively via third party service 106. In some embodiments, client system 102 may request that the tickets be sold both on a ticket buying platform hosted by a third party service 106 (e.g., ticket sale platform 107) and a ticket buying platform hosted by client system 102 (e.g., ticket sale platform 115). In some embodiments, client system 102 may request that the tickets be sold via multiple third party services 106.

At operation 604, organization computing system 104 may generate one or more APIs. For example, API module 118 may generate one or more APIs that allow a third party service 106 or computing system 102 to access a functionality of dynamic pricing agent 116. API module 118 may generate one or more APIs that allow for the seamless transfer of data between third party service 106 and/or computing system 102 and organization computing system 104. For example, one or more APIs may allow third party service 106 to receive dynamic pricing information for tickets posted to a ticket buying platform hosted thereon. In another example, one or more APIs may allow third party service 106 to transmit ticket sale data to organization computing system 104, such that dynamic pricing agent 116 may continually or periodically update the price of each ticket associated with an event, by, for example, updating the event score and/or spring value.

At operation 606, organization computing system 104 may notify third party service 106 and/or computing system 102 that one or more APIs are available. For example, API module 118 may notify third party service 106 and/or computing system 102 that one or more APIs that link a functionality of dynamic pricing agent 116 to third party service 106 is available for use.

In some embodiments, block diagram 600 may further include operation 608. At operation 608, third party service 106 may generate one or more API endpoints. For example, third party service 106 may generate one or more API endpoints through which organization computing system 104 may retrieve updated ticket sales data from third party service 106. Such API endpoints may reduce or eliminate the need for multiple requests from dynamic pricing agent 116 to third party service 106 for the dynamic pricing analysis.

At operation 610, client system 102 may transmit event information to organization computing system 104. Event information may include, for example, each available ticket for the event (e.g., seat number, row number, section number, etc.), a home team, an away team, a location of the event (e.g., arena/stadium name, city, state, etc.), a date and time of the event, and the like.

At operation 614, organization computing system 104 may receive the event information from client system 102. Dynamic pricing agent 116 may parse the event information to identify one or parameters for which additional information is needed. For example, dynamic pricing agent 116 may identify the home team, the away team, and a date and time of the event. Based on this information, dynamic pricing agent 116 may retrieve or request additional data from one or more data sources 108. For example, dynamic pricing agent 116 may request from one or more data sources 108 information directed to a win/loss ratio of the home team, a win/loss ratio of the away team, a type of event (e.g., pre-season, regular season, post-season, championship, etc.), historical ticket sale information, and weather forecast information for the date and time of the event.

At operation 616, each data source 108 may receive a respective request from organization computing system 104. Each data source 108 may query a database associated therewith to pull the requested information for organization computing system 104. Each data source 108 may transmit the requested information to organization computing system 104 for further analysis. Although not explicitly discussed above in conjunction with operation 604, those skilled in the art may understand that organization computing system 104 may further generate one or more APIs that allow organization computing system 104 and data sources 108 to communicate.

At operation 618, organization computing system 104 may generate a price for each available ticket based on the identified attributes of the event. For example, dynamic pricing agent 116 may generate an event score and a spring value, via specific prediction model 132, based at least one of a seat number, a seat row, a seat section, a date of the event, a time of the event, a number of available tickets for the event, an event type (e.g., regular season, playoffs, championship, pre-season, etc.), a city in which the event takes place, win/loss ratio of the home team, win/loss ratio of the away team, weather forecast for the day and time of the event, and the like. After generation of the event score and the spring value, dynamic pricing agent 116 may generate a price for each ticket. For example, dynamic pricing agent 116 may generate a price for each ticket based on, one or more of, the event score, the spring value, the seat represented by the ticket, event specific data, event conditions, and the like.

At operation 620, organization computing system 104 may transmit the generated ticket prices to third party service 106 and/or client system 102 for posting. For example, dynamic pricing agent 116 may transmit the generated prices to third party service 106 and/or client system 102 via one or more APIs. At operation 622, third party service 106 may post the tickets and corresponding prices to ticket buying platform.

At operation 624, third party service 106 may receive a plurality of transaction requests from a plurality of user devices. The plurality of transaction requests may correspond to ticket purchased for a given event. At operation 625, client system 102 may receive a plurality of transaction request from a plurality of user devices. The plurality of transaction requests may correspond to ticket purchased for a given event. At operation 626, third party service 106 may transmit the transaction data to organization computing system. Such transaction data may include information directed to the specific ticket purchased, such as the seat number, the row, and the section. Such transaction data may further include the date and time at which each ticket was purchased, the price of each ticket, and the quantity of tickets. In some embodiments, rather than transmitting the transaction data from third party service 106 and client system 102 to organization computing system 104, organization computing system 104 may retrieve or pull the transaction data from third party service 106 and client system 102 via the one or more APIs.

At step 627, organization computing system 104 may synchronize ticket sales with each of client system 102 and third party service 106. For example, if party A purchased ticket A from third party service 106, organization computing system 104 may communicate with client system 102 to de-list ticket A from ticket sale platform 115. Similarly, if party B purchased ticket B from client system 102, organization computing system 104 may communicate with third party service 106 to de-list ticket B from ticket sale platform 107. In some embodiments, organization computing system 104 may further delist the tickets from other secondary markets. For example, if the purchase was received from a first third party service 106, and tickets for the event were also being sold view client system 102 (e.g., primary integration) and another third party service 106, organization computing system 104 may delist the tickets from client system 102 and the other third party service 106.

At operation 628, organization computing system 104 may dynamically adjust the price of each available ticket based on the updated information. Dynamically adjusting the price of each available ticket may include requesting updated data from one or more data sources 108. Dynamic pricing agent 116 may generate an updated event score and updated spring value, via specific prediction model 132, based on the updated information, and at least one of a date of the event, a time of the event, a number of available tickets for the event, velocity of ticket sales, an event type (e.g., regular season, playoffs, championship, pre-season, opening day, first show, etc.), a city in which the event takes place, updated win/loss ratio of the home team, updated win/loss ratio of the away team, updated weather forecast for the day and time of the event, and the like. After generating the updated event score and the updated spring value, dynamic pricing agent 116 may generate an updated price for each ticket based on, one or more of, the updated event score, the updated spring value, the seat represented by the ticket, event specific data, event conditions, and the like.

At operation 630, organization computing system 104 may transmit the updated price information for each available ticket to third party service 106 for updating.

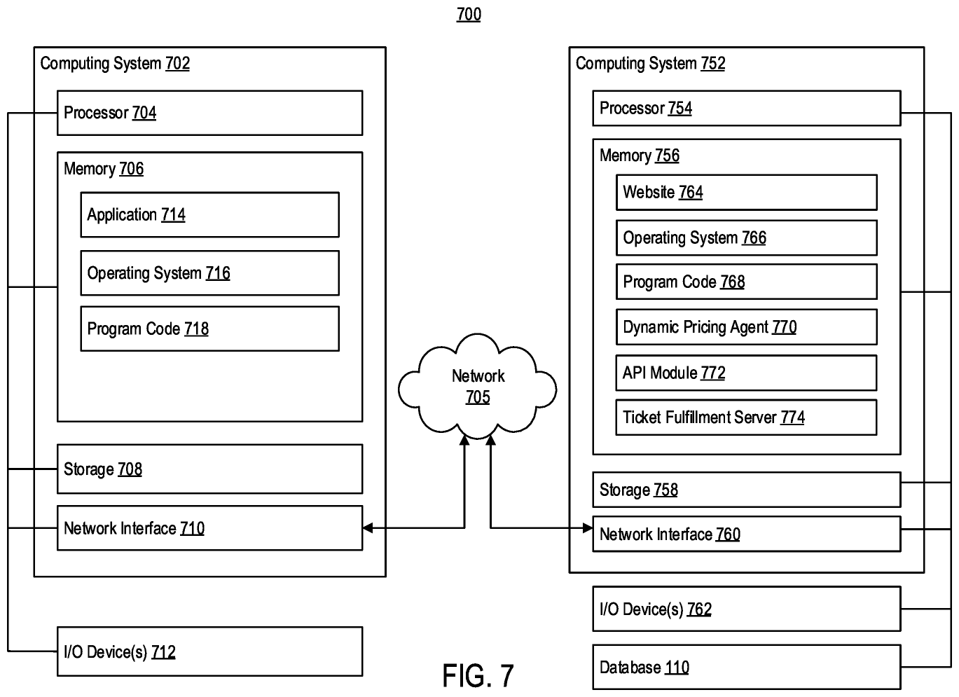

FIG. 7 is a block diagram illustrating an exemplary computing environment 700, according to some embodiments. Computing environment 700 includes computing system 702 and computing system 752. Computing system 702 may be representative of client system 102. Computing system 752 may be representative of organization computing system 104.

Computing system 702 may include a processor 704, a memory 706, a storage 708, and a network interface 710. In some embodiments, computing system 702 may be coupled to one or more I/O device(s) 712 (e.g., keyboard, mouse, etc.).

Processor 704 may retrieve and execute program code 720 (i.e., programming instructions) stored in memory 706, as well as stores and retrieves application data. Processor 704 may be included to be representative of a single processor, multiple processors, a single processor having multiple processing cores, and the like. Network interface 710 may be any type of network communications allowing computing system 702 to communicate externally via computing network 705. For example, network interface 710 is configured to enable external communication with computing system 752.

Storage 708 may be, for example, a disk storage device. Although shown as a single unit, storage 708 may be a combination of fixed and/or removable storage devices, such as fixed disk drives, removable memory cards, optical storage, network attached storage (NAS), storage area network (SAN), and the like.

Memory 706 may include application 714, operating system 716, and program code 718. Program code 718 may be accessed by processor 704 for processing (i.e., executing program instructions). Program code 718 may include, for example, executable instructions for communicating with computing system 752 to display one or more pages of website 764. Application 714 may enable a user of computing system 702 to access a functionality of computing system 752. For example, application 714 may access content managed by computing system 752, such as website 764. The content that is displayed to a user of computing system 702 may be transmitted from computing system 752 to computing system 702, and subsequently processed by application 716 for display through a graphical user interface (GUI) of computing system 702.

Computing system 752 may include a processor 754, a memory 756, a storage 758, and a network interface 760. In some embodiments, computing system 752 may be coupled to one or more I/O device(s) 762. In some embodiments, computing system 752 may be in communication with database 110.

Processor 754 may retrieve and execute program code 768 (i.e., programming instructions) stored in memory 756, as well as stores and retrieves application data. Processor 754 is included to be representative of a single processor, multiple processors, a single processor having multiple processing cores, and the like. Network interface 760 may be any type of network communications enabling computing system 752 to communicate externally via computing network 705. For example, network interface 760 allows computing system 752 to communicate with computer system 702.

Storage 758 may be, for example, a disk storage device. Although shown as a single unit, storage 758 may be a combination of fixed and/or removable storage devices, such as fixed disk drives, removable memory cards, optical storage, network attached storage (NAS), storage area network (SAN), and the like.

Memory 756 may include website 764, operating system 766, program code 768, dynamic pricing agent 770, API module 772, and ticket fulfillment server 774. Program code 768 may be accessed by processor 754 for processing (i.e., executing program instructions). Program code 768 may include, for example, executable instructions configured to perform one or more operations discussed above in conjunction with FIGS. 2-6. As an example, processor 754 may access program code 768 to perform operations related training and testing a prediction model for generating ticket prices. In another example, processor 754 may access program code 768 to dynamically price tickets for a given event. Website 764 may be accessed by computing system 702. For example, website 764 may include content accessed by computing system 702 via a web browser or application.

Dynamic pricing agent 770 may be configured to dynamically price each ticket for a given event. For example, dynamic pricing agent 770 may be configured to dynamically price each ticket by generating an event score and a spring value for each event using one or more machine learning models. Dynamic pricing agent 770 may generate the event score and spring value for each event based on, for example, one or more of win/loss ratio of each team in the event, forecasted weather conditions, number of tickets available, location of each seat, historical ticket sales, velocity of ticket sales, quality of opponent, event location, and the like. Dynamic pricing agent 770 may leverage, for example, a machine learning module to dynamically generate an event score and a spring value for each event. After generation of the event score and spring value, dynamic pricing agent 770 may generate a price for each available ticket using the event score and the spring value. For example, dynamic pricing agent 770 may generate a price for each ticket based on, one or more of, the event score, the spring value, the seat represented by the ticket, event specific data, event conditions, and the like.

API module 772 may include one or more instructions to execute one or more APIs that provide various functionalities related to the operations of computing system 752. In some embodiments, API module 772 may include an API adapter that allows API module 772 to interface with and utilize enterprise APIs maintained by computing system 752 and/or an associated entity that may be hosted on other systems or devices. In some embodiments, APIs may enable computing system 752 to communicate with one or more of data sources and third party services. For example, computing system 752 may be configured to retrieve one or more sets of data from one or more endpoints defined at one or more data sources. Similarly, computing system 752 may be configured to receive or retrieve one or more sets of ticket sales data from an endpoint defined at a third party service.

Ticket fulfillment server 774 may be configured to fulfill one or more ticket orders. For example, ticket fulfillment server 774 may be configured to maintain an inventory of tickets, as users purchase tickets. In some embodiments, ticket fulfillment server 774 may receive ticket orders directly, via a ticket sale platform hosted by computing system 752. In some embodiments, ticket fulfillment server 774 may receive ticket orders via one or more primary or secondary integrations. For example, ticket fulfillment server 774 may receive ticket orders via one or more third party services, which may be configured to host a dedicated ticket sale platform. In some embodiments, ticket fulfillment server 774 may include multiple sub-services that may be created dynamically for each team.

Ticket fulfillment server 774 may further be configured to synchronize database 110 with tickets currently available via computing system 752 or a third party service. For example, upon receiving one or more ticket transactions via a third party service, ticket fulfillment server 774 may synchronize the data with database 110. Synchronizing the ticket sale information with database 110 may aid in ensuring that no ticket is sold twice. Further, synchronizing the ticket sale information with database 110 may aid in dynamically pricing unsold tickets. For example, dynamic pricing agent 770 may leverage ticket sale information to determine an updated event score and/or updated spring value, based on, for example, the velocity at which other tickets for the event are being sold. The updated event score and/or updated spring value may be used to generate updated ticket prices.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method of dynamically pricing tickets for an event, comprising:
retrieving, by a computing system, historical pricing information for a given team, the historical pricing information comprising ticket sale information for a plurality of events;
constructing, by the computing system, a first plurality of training data sets based on historical pricing information wherein each training data set of the first plurality of training data sets comprises team-specific information, opponent-specific information, and historical ticket sale data;
training, by the computing system, a first prediction model to generate an event score for each event of the plurality of events by identifying relationships among the team-specific information, the opponent specific information, and the historical ticket sale data, wherein the event score corresponds to a lowest priced ticket for the event;
constructing, by the computing system, a second plurality of training data sets based on the historical ticket sale data, each training data set of the second plurality of training data sets comprising the team-specific information, the opponent-specific information, and relative pricing information for a corresponding event, wherein the relative pricing information corresponds to the relative pricing between sections or rows of the corresponding event;
training, by the computing system, a second prediction model to generate a spring value for each event of the plurality of events by identifying relationships between the relative pricing information for the corresponding event, the team-specific information, and the opponent specific information;
receiving, by the computing system, a request to adjust the first prediction model and the second prediction model to increase attendance for future events;
based on the request, adjusting, by the computing system, weights associated with both the first prediction model and the second prediction model;
retraining, by the computing system, the first prediction model to generate a new event score that increases attendance for future events; and
retraining, by the computing system, the second prediction model to generate a new spring value that increases attendance for future events.

2. The method of claim 1, wherein the event score and the spring value are used to generate a price for each for a respective event.

3. The method of claim 1, further comprising:
receiving, by the computing system, ticket sale data for the upcoming event, the ticket sale data comprising a specification of each ticket purchased and a time at which each ticket was purchase;
updating, by the computing system via the first prediction model, the event score based on the ticket sale data; and
updating, by the computing system via the second prediction model, the spring value based on the ticket sale data.

4. The method of claim 1, further comprising:
retrieving from a data source updated team-specific information and updated opponent-specific information;
updating, by the computing system via the first prediction model, the event score based on the updated team-specific information and the updated opponent-specific information; and
updating, by the computing system via the second prediction model, the spring value based on the updated team-specific information and the updated opponent-specific information.

5. The method of claim 1, further comprising:
retrieving from a data source weather forecast information for a time and date of the event;
generating the event score, via the first prediction model, based on the weather forecast information; and
generating the spring value, via the second prediction model, based on the weather forecast information.

6. The method of claim 1, further comprising:
generating, by the computing system, a third predictive model for a second team, wherein the given team and the second team are members of the same league.

7. The method of claim 6, further comprising:
generating, by the computing system, a generic prediction model for the league by identifying common traits among the first prediction model and the third prediction model and generalizing the first prediction model and the third prediction model based on the identified common traits.

8. A system, comprising:
a processor; and
a memory having programming instructions stored thereon, which, when executed by the processor, perform one or more operations comprising:
retrieving historical pricing information for a given team, the historical pricing information comprising ticket sale information for a plurality of events;
generating a first predictive model using a machine learning model, by:
generating a first plurality of training data sets based on historical pricing information, wherein each training data set of the first plurality of training data sets comprises team-specific information, opponent-specific information, and historical ticket sale data; and
learning, by the first machine learning model, an event score for each event of the plurality of events by identifying relationships among the team-specific information, the opponent-specific information, and the historical ticket sale data, wherein the event score corresponds to a lowest priced ticket for the event;
generating a second predictive model using a second machine learning model, by:
generating a second plurality of training data sets based on the historical ticket sale data, each training data set of the second plurality of training data sets comprising the team-specific information, the opponent-specific information, and relative pricing information for a corresponding event, wherein the relative pricing information corresponds to the relative pricing between sections or rows of the corresponding event; and
learning, by the second machine learning model, a spring value for each event of the plurality of events by identifying relationships between the relative pricing information for the corresponding event, the team-specific information, and the opponent specific information;
receiving a request to adjust the first prediction model and the second prediction model to generate a new event score and a new spring value that increases attendance for future events;
based on the request, adjusting weights associated with both the first prediction model and the second prediction model;
retraining the first prediction model to generate a new event score that increases attendance for future events; and
retraining the second prediction model to generate a new spring value that increases attendance for future events.

9. The system of claim 8, wherein the event score and the spring value are used to generate a price for each ticket for a respective event.

10. The system of claim 8, wherein the one or more operations further comprise:
receiving ticket sale data for the upcoming event, the ticket sale data comprising a specification of each ticket purchased and a time at which each ticket was purchase;
updating, via the first prediction model, the event score based on the ticket sale data; and
updating, via the second prediction model, the spring value based on the ticket sale data.

11. The system of claim 8, wherein the one or more operations further comprise:
retrieving from a data source updated team-specific information and updated opponent-specific information;
updating, via the first prediction model, the event score based on the updated team-specific information and the updated opponent-specific information; and
updating, via the second prediction model, the spring value based on the updated team-specific information and the updated opponent-specific information.

12. The system of claim 8, wherein the one or more operations further comprise:
retrieving from a data source weather forecast information for a time and date of the event;
generating the event score, via the first prediction model, based on the weather forecast information; and
generating the spring value, via the second prediction model, based on the weather forecast information.

13. The system of claim 8, wherein the one or more operations further comprise:
generating a second predictive model for a second act, wherein the given act and the second act are within a same category of acts.

14. The system of claim 8, wherein the one or more operations further comprise:
generating, a generic prediction model for the league by identifying common traits among the first prediction model and the third prediction model and generalizing the first prediction model and the third prediction model based on the identified common traits.

15. A non-transitory computer readable medium including one or more sequences of instructions that, when executed by the one or more processors, causes:
retrieving historical pricing information for a given team, the historical pricing information comprising ticket sale information for a plurality of events;
generating a first predictive model using a first machine learning model, by:
generating a first plurality of training data sets based on historical pricing information, wherein each training data set of the first plurality of training data sets comprises team-specific information, opponent-specific information, and historical ticket sale data; and
learning, by the first machine learning model, an event score for each event of the plurality of events by identifying relationships among the team-specific information, the opponent-specific information, and the historical ticket sale data, wherein the event score corresponds to a lowest priced ticket for the event;
generating a second predictive model using a second machine learning model, by:
generating a second plurality of training data sets based on the historical ticket sale data, each training data set of the second plurality of training data sets comprising the team-specific information, the opponent-specific information, and relative pricing information for a corresponding event, wherein the relative pricing information corresponds to the relative pricing between sections or rows of the corresponding event; and
learning, by the second machine learning model, a spring value for each event of the plurality of events by identifying relationships between the relative pricing information for the corresponding event, the team-specific information, and the opponent specific information;
receiving a request to adjust the first prediction model and the second prediction model to generate a new event score and a new spring value that increases attendance for future events;
based on the request, adjusting, by the computing system, weights associated with both the first prediction model and the second prediction model;
retraining, by the computing system, the first prediction model to generate a new event score that increases attendance for future events; and
retraining, by the computing system, the second prediction model to generate a new spring value that increases attendance for future events.

16. The non-transitory computer readable medium of claim 15, wherein the event score and the spring value are used to generate a price for each for a respective event.

17. The non-transitory computer readable medium of claim 15, wherein the one or more processors further cause:
receiving ticket sale data for the upcoming event, the ticket sale data comprising a specification of each ticket purchased and a time at which each ticket was purchase;
updating, via the first prediction model, the event score based on the ticket sale data; and
updating, via the second prediction model, the spring value based on the ticket sale data.

18. The non-transitory computer readable medium of claim 15, wherein the one or more operations further cause:
retrieving from a data source updated team-specific information and updated opponent-specific information;
updating, via the first prediction model, the event score based on the updated team-specific information and the updated opponent-specific information; and
updating, via the second prediction model, the spring value based on the updated team-specific information and the updated opponent-specific information.

19. The non-transitory computer readable medium of claim 15, wherein the one or more processors further cause:
generating, a third predictive model for a second team, wherein the given team and the second team are members of the same league.

20. The non-transitory computer readable medium of claim 15, wherein the one or more processors further cause:
generating, a generic prediction model for the league by identifying common traits among the first prediction model and the third prediction model and generalizing the first prediction model and the third prediction model based on the identified common traits.
